(19) United States
(12) Patent Application Publication
(10) Pub. No.: US 2024/0313874 A1
(43) Pub. Date: Sep. 19, 2024

(54) TRANSMISSION DEVICE, TRANSMISSION METHOD, AND RECEPTION DEVICE

(71) Applicant: SONY GROUP CORPORATION, TOKYO (JP)

(72) Inventor: KAZUYUKI TAKAHASHI, TOKYO (JP)

(21) Appl. No.: 18/571,055

(22) PCT Filed: Feb. 10, 2022
(86) PCT No.: PCT/JP2022/005249

§ 371 Date: Dec. 15, 2023

(30) Foreign Application Priority Data
Jun. 24, 2021 (JP) 2021-105070

(51) Int. Cl. H04H 20/20; H04H 20/95; H04H 60/41

(52) U.S. Cl. CPC H04H 20/20; H04H 20/95; H04H 60/41

(57) ABSTRACT

The present disclosure relates to a transmission device, a transmission method, and a reception device capable of recognizing simultaneous broadcasting more reliably. Provided is a transmission device including: a generation unit that generates a broadcast stream including a broadcast component constituting content and signaling information regarding the broadcast component; and a transmission unit that transmits the broadcast stream, in which the signaling information includes a descriptor in which a service identifier or location information for identifying simultaneous broadcasting content corresponding to the content is arranged. The present disclosure can be applied to, for example, a transmission system corresponding to a broadcasting system of terrestrial digital television broadcasting.

### TECHNICAL FIELD

The present disclosure relates to a transmission device, a transmission method, and a reception device, and more particularly, to the transmission device, the transmission method, and the reception device capable of recognizing simultaneous broadcasting more reliably.

### BACKGROUND ART

Advancement of digital television broadcasting for the next generation has been studied. When an operation of a broadcasting service of a next generation system is started, simultaneous broadcasting is performed for the time being.

As a technique related to the simultaneous broadcasting, for example, there is a technique disclosed in Non-Patent Document 1. In Non-Patent Document 1, it is possible to specify a major channel number and a minor channel number of a broadcasting system that perform the simultaneous broadcasting.

### CITATION LIST

### Non-Patent Document

Non-Patent Document 1: ATSC Standard: “Signaling, Delivery, Synchronization, and Error Protection” Doc. A/331:2020, 16 Jan. 2020

### SUMMARY OF THE INVENTION

### Problems to be Solved by the Invention

When simultaneous broadcasting is operated, a receiver side needs to recognize that the simultaneous broadcasting is being performed. Therefore, proposals for reliably recognizing the simultaneous broadcasting have been requested.

The present disclosure has been made in view of such a situation, and an object of the present disclosure is to enable the simultaneous broadcasting to be recognized more reliably.

### Solutions to Problems

A transmission device of one aspect of the present disclosure is a transmission device including: a generation unit that generates a broadcast stream including a broadcast component constituting content and signaling information regarding the broadcast component; and a transmission unit that transmits the broadcast stream, in which the signaling information includes a descriptor in which a service identifier or location information for identifying simultaneous broadcasting content corresponding to the content is arranged.

A transmission method according to one aspect of the present disclosure is a transmission method performed by a transmission device, including: generating a broadcast stream including a broadcast component constituting content and signaling information regarding the broadcast component, the signaling information including a descriptor in which a service identifier or location information for identifying simultaneous broadcasting content corresponding to the content is arranged; and transmitting the broadcast stream.

In a transmission device and a transmission method according to one aspect of the present disclosure, generated is a broadcast stream including a broadcast component constituting content and signaling information regarding the broadcast component, the signaling information including a descriptor in which a service identifier or location information for identifying simultaneous broadcasting content corresponding to the content is arranged, and the broadcast stream is transmitted.

A reception device according to one aspect of the present disclosure includes: a reception unit that receives a broadcast stream including a broadcast component constituting content and signaling information regarding the broadcast component; and a processing unit that processes the broadcast component on the basis of the signaling information, in which the signaling information includes a descriptor in which a service identifier or location information for identifying simultaneous broadcasting content corresponding to the content is arranged.

In a reception device according to one aspect of the present disclosure, received is a broadcast stream including a broadcast component constituting content and signaling information regarding the broadcast component, the signaling information including a descriptor in which a service identifier or location information for identifying simultaneous broadcasting content corresponding to the content is arranged, and the broadcast component is processed on the basis of the signaling information.

Note that, a transmission device and a reception device according to one aspect of the present disclosure may be independent devices or may be internal blocks constituting one device

### BRIEF DESCRIPTION OF DRAWINGS

FIG. 1 is a block diagram illustrating a configuration example of an embodiment of a transmission system to which the present disclosure is applied.

FIG. 2 is a block diagram illustrating a configuration example of a transmission device of FIG. 1.

FIG. 3 is a block diagram illustrating a configuration example of a reception device of FIG. 1.

FIG. 4 is a diagram illustrating an example of syntax of a simultaneous broadcasting descriptor.

FIG. 5 is a diagram illustrating an example of semantics of the simultaneous broadcasting descriptor.

FIG. 6 is a diagram illustrating an example of system_type.

FIG. 7 is a diagram illustrating an example of transmission_mode.

FIG. 8 is a diagram illustrating an example of guard_interval.

FIG. 9 is a diagram illustrating an example of a minimum configuration of the simultaneous broadcasting descriptor.

FIG. 10 is a diagram illustrating an example of arrangement position of the simultaneous broadcasting descriptor.

FIG. 11 is a diagram illustrating an example of transmission of service_id.

FIG. 12 is a diagram illustrating an example of transmission of remote_control_key_id.

FIG. 13 is a flowchart illustrating an operational flow at the time of initial scanning in the reception device.

FIG. 14 is a diagram illustrating a first example of transmission of video resolution information.

FIG. 15 is a diagram illustrating an example of video_resolution.

FIG. 16 is a diagram illustrating a second example of the transmission of the video resolution information.

FIG. 17 is a diagram illustrating examples of stream_content and component_type.

FIG. 18 is a flowchart illustrating an operational flow at the time of selection in the reception device.

FIG. 19 is a flowchart illustrating flows of processing on the transmission side and the reception side to which the present disclosure is applied.

FIG. 20 is a block diagram illustrating a configuration example of a computer.

### MODE FOR CARRYING OUT THE INVENTION

### 1. Embodiment of Present Disclosure

### (Configuration of Transmission System)

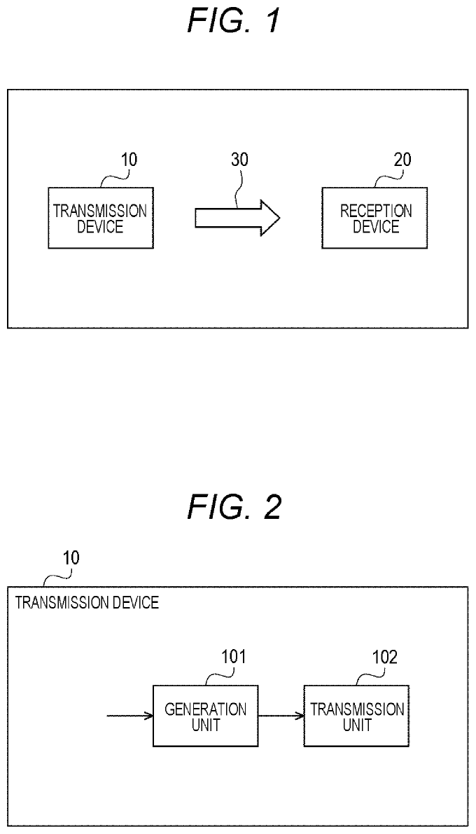

FIG. 1 is a block diagram illustrating a configuration example of an embodiment of a transmission system to which the present disclosure is applied.

In FIG. 1, the transmission system includes a transmission device 10 and a reception device 20.

The transmission device 10 generates a broadcast stream and transmits the broadcast stream as a broadcast signal. The broadcast stream includes a broadcast component constituting content such as a program or a commercial, and signaling information regarding the broadcast component.

The reception device 20 is a fixed receiver such as a television receiver, a set top box (STB), a recorder, a game machine, or a network storage, or an in-vehicle receiver mounted on a vehicle such as an in-vehicle television. In addition, the reception device 20 may be a mobile receiver such as a smartphone, a mobile phone, or a tablet computer.

The reception device 20 receives a broadcast signal transmitted from the transmission device 10 via a transmission path 30. The reception device 20 outputs video and audio of the content such as a program by processing the broadcast component on the basis of the signaling information acquired from the broadcast stream. As a result, a user can view the content such as a program.

### (Configuration of Transmission Device)

FIG. 2 is a block diagram illustrating a configuration example of the transmission device 10 of FIG. 1.

In FIG. 2, the transmission device 10 includes a generation unit 101 and a transmission unit 102.

The generation unit 101 generates a broadcast stream including a broadcast component constituting content and signaling information, and supplies the broadcast stream to the transmission unit 102.

The content is a program produced by a broadcast station or the like, and the broadcast component is input into the generation unit 101. The broadcast component includes components of a video stream and an audio stream. The broadcast component may further include other components such as a subtitle stream.

The signaling information is control information used in processing of an upper layer, and is signaling information regarding the broadcast component. The upper layer is a layer upper than a physical layer. The generation unit 101 generates the signaling information on the basis of the information input thereto.

The transmission unit 102 performs necessary processing such as modulation processing on the broadcast stream supplied from the generation unit 101, thereby transmitting the broadcast stream as a broadcast signal. The broadcast signal is transmitted from a transmission antenna installed in a transmission station.

### (Configuration of Reception Device)

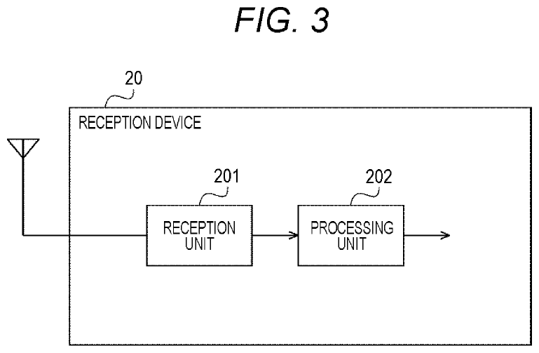

FIG. 3 is a block diagram illustrating a configuration example of the reception device 20 of FIG. 1.

In FIG. 3, the reception device 20 includes a reception unit 201 and a processing unit 202.

The reception unit 201 includes a tuner, a demodulation large scale integration (LSI), and the like. The reception unit 201 performs necessary processing such as demodulation processing on the broadcast signal received via the antenna, and supplies a resulting broadcast stream to the processing unit 202.

The processing unit 202 includes a main system on chip (SoC) and the like. The processing unit 202 performs necessary processing such as decoding processing and reproduction processing on the broadcast stream supplied from the reception unit 201. The broadcast stream includes the broadcast component and the signaling information. For example, in the decoding processing and the reproduction processing, the data of the broadcast component is decoded and reproduced on the basis of the signaling information.

Data such as video or audio acquired by processing such as the decoding processing or the reproduction processing is output to a subsequent circuit. As a result, in the reception device 20, video of content such as a program is displayed on a display, and audio synchronized with the video is output from a speaker.

In the transmission system configured as described above, the broadcast stream generated by the transmission device 10 is received by the reception device 20 via the transmission path 30 and processed by the reception device 20, so that the content such as a program can be viewed.

Note that, in the configuration described above, the transmission device 10 includes the generation unit 101 and the transmission unit 102. However, the generation unit 101 and the transmission unit 102 may be provided in different devices from each other. That is, the transmission device 10 may be configured as a system for transmission including a device including the generation unit 101 and a device including the transmission unit 102. In addition, in the above-described configuration, the case where the number of the reception device 20 is one has been exemplified, but a plurality of the reception devices 20 is actually provided. The reception device 20 may have a communication function.

### (Outline of Broadcasting System)

In the transmission system of FIG. 1, a broadcasting system such as integrated services digital broadcasting-terrestrial (ISDB-T) can be adopted. For example, in Japan, ISDB-T is adopted as the broadcasting system of terrestrial digital television broadcasting, and a next generation system (advanced terrestrial broadcasting system) of the terrestrial digital television broadcasting has been considered. Hereinafter, the current ISDB-T is referred to as a current system and distinguished from the next generation system.

In operating a broadcasting service of the next generation system, a broadcaster is required to operate simultaneous broadcasting with the broadcasting service of the current system. For example, when providing the broadcasting service of the next generation system, the broadcaster also provides the broadcasting service of the current system which is the simultaneous broadcasting of the broadcasting service of the next generation system.

As the simultaneous broadcasting, an operation of providing the same programs with different qualities at the same time is usually performed. For example, there is an operation in which one of the same programs is broadcasted as video with the 2K image quality in the broadcasting service of the current system, and the other of the same programs is broadcasted as video with the 4K image quality in the broadcasting service of the next generation system. In this operation, a video program with the 2K image quality (a program of the simultaneous broadcasting) can be broadcasted as simultaneous broadcasting content corresponding to content that is a video program with the 4K image quality. Hereinafter, the broadcasting service of the current system is also referred to as 2K broadcasting since a video program with the 2K image quality is broadcasted. In addition, the broadcasting service of the next generation system is also referred to as the 4K broadcasting because a video program with the 4K image quality is broadcasted.

As described above, when an operation of the broadcasting service of the next generation system is started, the simultaneous broadcasting is performed for the time being, and thus, the same programs are broadcasted with different video resolutions (4K image quality and 2K image quality). At this time, the reception device 20 needs to recognize that the simultaneous broadcasting is being performed.

For example, in a case where the reception device 20 receives a broadcast signal including the simultaneous broadcasting but cannot determine that the broadcast signal is the simultaneous broadcasting, a plurality of the same programs is included in a channel list, and thus, the plurality of the same programs is displayed. The display of the plurality of the same programs may confuse a user, and thus, it is necessary to prevent the same programs from being included in the channel list.

The simultaneous broadcasting is performed at the time of introduction of the broadcasting service of the next generation system. Therefore, in standardization of the current system, the simultaneous broadcasting is not assumed and a descriptor regarding the simultaneous broadcasting is not defined.

Therefore, in the present disclosure, at the start of an operation of a new broadcasting service such as the next generation system, a simultaneous broadcasting descriptor is defined and transmitted from the transmission device 10 to the reception device 20, so that the reception device 20 can reliably recognize that the simultaneous broadcasting is being performed. As a result, when receiving the broadcast signal, the reception device 20 can determine whether or not the broadcast signal is the simultaneous broadcasting.

### (Structure of Simultaneous Broadcasting Descriptor)

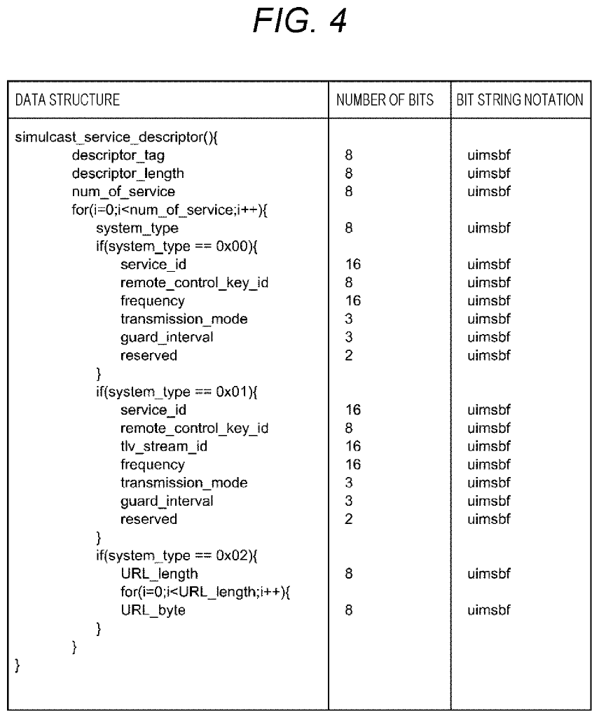

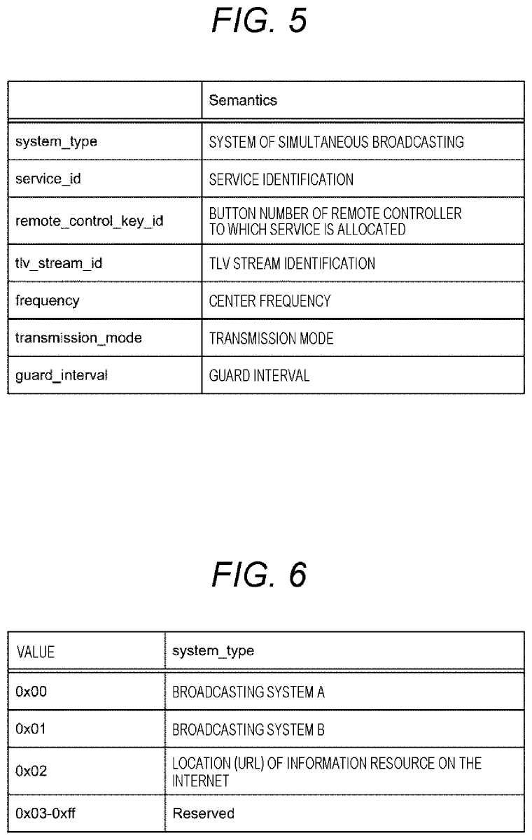

FIG. 4 is a diagram illustrating an example of syntax of the simultaneous broadcasting descriptor (simulcast_service_descriptor). Semantics will be described with reference to FIG. 5 as appropriate.

8-bit descriptor_tag indicates a tag for identifying the simultaneous broadcasting descriptor. 8-bit descriptor_length indicates a length of a subsequent field. 8-bit num_of_service indicates the number of services.

In a loop corresponding to the number of services specified by num_of_service, system_type is arranged, and service_id, remote_control_key_id, tlv_stream_id, frequency, transmission_mode, guard_interval, URL_length, and URL_byte are arranged according to a value of system_type.

8-bit system_type indicates a system of the simultaneous broadcasting. FIG. 6 illustrates an example of system_type. As illustrated in FIG. 6, in a case where the simultaneous broadcasting is performed in a broadcasting system A and a broadcasting system B, the values of system_type are “0x00” and “0x01”. For example, the current system and the next generation system correspond to the broadcasting system A and the broadcasting system B.

In addition, in a case where the simultaneous broadcasting is distributed from a server via the Internet, the value of system_type is “0x02”. Note that, as a system of the simultaneous broadcasting, other systems may be specified, and in this case, reserve values of “0x03” to “0xff” can be used as system_type.

16-bit service_id indicates an identifier (service ID) for identifying a service. Pieces of content having the same value of service_id may be the same piece of content. However, even if the pieces of content have the same value of service_id, the pieces of content may have different video resolutions.

Alternatively, the pieces of content of different video resolutions may have different values of service_id. In this case, the service ID of the same pieces of content can be indicated for each value of system_type by the simultaneous broadcasting descriptor of FIG. 4.

8-bit remote_control_key_id indicates an identifier for identifying a button number (remote controller button number) of a remote controller to which the service is allocated. The remote controller button number is obtained by allocating a number for a key of the remote controller to each broadcasting station separately from a channel of a frequency band.

16-bit tlv_stream_id indicates an identifier for identifying a TLV stream. The TLV stream is a sequence of a type length value (TLV) packets, and is identified by the TLV stream ID. In the TLV stream, the TLV packet storing the broadcast component and the TLV packet storing the signaling information are multiplexed.

The frequency, the transmissobtainion_mode, and guard_interval are selection information. Note that, 2-bit reserved is a region for future extension.

16-bit frequency indicates a center frequency. As a unit of frequency, a unit corresponding to the broadcasting system of terrestrial digital television broadcasting can be used.

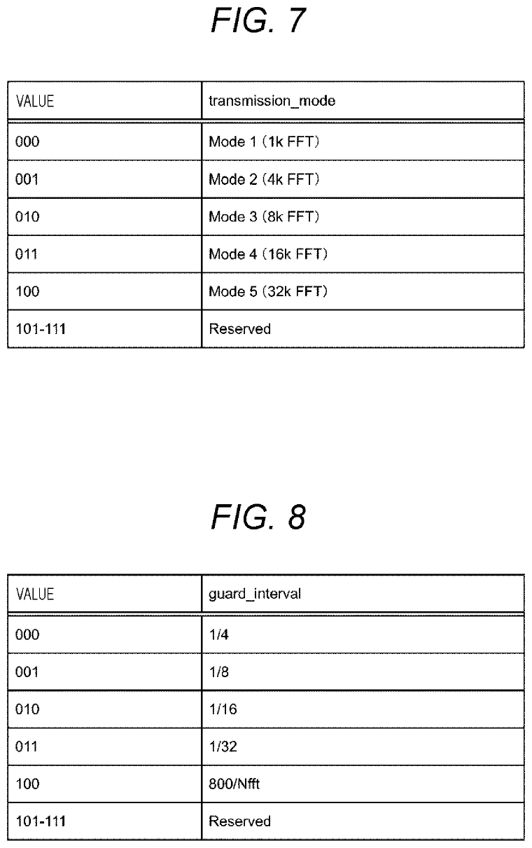

3-bit transmission_mode indicates a transmission mode. FIG. 7 illustrates an example of transmission_mode. As illustrated in FIG. 7, in a case where “000” is specified as a value of transmission_mode, the transmission mode is mode 1 that is 1k FFT. Similarly, in a case where “001”, “010”, “011”, and “100” are specified as values of transmission_mode, the transmission modes are mode 2 (4k FFT), mode 3 (8k FFT), mode 4 (16k FFT), and mode 5 (32k FFT).

3-bit guard_interval indicates a guard interval. FIG. 8 illustrates an example of guard_interval. As illustrated in FIG. 8, in a case where “000” is specified as a value of guard_interval, the ratio of the guard interval is 1/4. Similarly, in a case where “001”, “010”, “011”, and “100” are specified as values of guard_interval, the ratios of the guard intervals are 1/8, 1/16, 1/32, and 800/Nfft.

Location information is specified by URL_length and URL_byte. 8-bit URL_length indicates a length of a field of URL_byte. URL_byte indicates a uniform resource locator (URL) indicating a location of an information resource on the Internet.

A broadcast stream including the simultaneous broadcasting descriptor having the above structure is transmitted from the transmission device 10 and received by the reception device 20. The reception device 20 can acquire the simultaneous broadcasting descriptor included in the received broadcast stream to determine the simultaneous broadcasting by service_id corresponding to the number of services of the simultaneous broadcasting specified by the num_of_service.

Here, in addition to service_id, information that can specify a program such as remote_control_key_id or tlv_stream_id, may be used to determine the simultaneous broadcasting. That is, by using at least one identifier of service_id, remote_control_key_id, and tlv_stream_id arranged in the simultaneous broadcasting descriptor, the reception device 20 can determine whether or not the programs are the same programs. In other words, the simultaneous broadcasting descriptor functions as an identifier for identifying a service corresponding to the program of the simultaneous broadcasting out of one or more services included in the transmission stream for transmitting the program of the simultaneous broadcasting.

In the simultaneous broadcasting descriptor, the selection information such as the frequency, transmission_mode, and guard_interval can be specified for each system_type together with an identifier such as service_id. By using this selection information, the reception device 20 can easily select the simultaneous broadcasting. In addition, even in a case where the reception device 20 is an in-vehicle receiver, a mobile receiver, or the like, and the reception environment changes due to mobile reception, it is possible to easily select the simultaneous broadcasting by using the selection information. Note that, as the selection information, it is not always necessary to specify all of the frequency, transmission_mode, and guard_interval, and other information may be specified.

In the simultaneous broadcasting descriptor of FIG. 4, in a case where system_type=“0x00” is satisfied, that is, in a case where the system of the simultaneous broadcasting is the broadcasting system A, service_id, remote_control_key_id, the frequency, transmission_mode, and guard_interval are arranged. service_id and remote_control_key_id are used to determine the simultaneous broadcasting. The frequency, transmission_mode, and guard_interval are the selection information of the simultaneous broadcasting.

In addition, in the simultaneous broadcasting descriptor of FIG. 4, in a case where system_type=“0x01” is satisfied, that is, in a case where the system of the simultaneous broadcasting is the broadcasting system B, service_id, remote_control_key_id, tlv_stream_id, the frequency, transmission_mode, and guard_interval are arranged. service_id, remote_control_key_id, and tlv_stream_id are used to determine the simultaneous broadcasting. The frequency, transmission_mode, and guard_interval are the selection information of the simultaneous broadcasting.

In addition, in the simultaneous broadcasting descriptor of FIG. 4, in a case where system_type=“0x02” is satisfied, that is, in a case where the simultaneous broadcasting is distributed via the Internet, URL_length and URL_byte are arranged. The URL indicating a location of an information resource on the Internet is specified as the location information by URL_length and URL_byte. Arrangement of the location information into the simultaneous broadcasting descriptor allows the reception device 20 to receive the program of the simultaneous broadcasting distributed via the Internet.

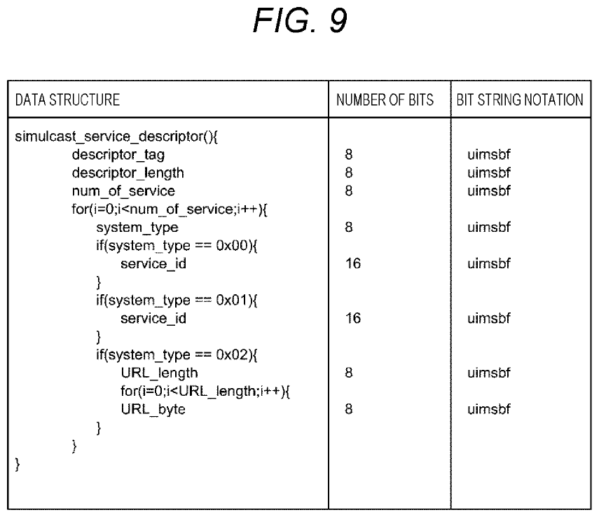

In the simultaneous broadcasting descriptor of FIG. 4, remote_control_key_id and tlv_stream_id are arranged as information that can specify the program of the simultaneous broadcasting, but it can be freely defined whether or not these pieces of information are arranged. In addition, it can also be freely defined whether or not the selection information such as the frequency, transmission_mode, and guard_interval is arranged. FIG. 9 illustrates an example of a minimum configuration of the simultaneous broadcasting descriptor.

In the simultaneous broadcasting descriptor of FIG. 9, service_id is arranged both in a case where system_type=“0x00” and in a case where system_type=“0x01”. In addition, in a case where system_type=“0x02”, URL_byte corresponding to URL_length is arranged.

### (Arrangement of Simultaneous Broadcasting Descriptor)

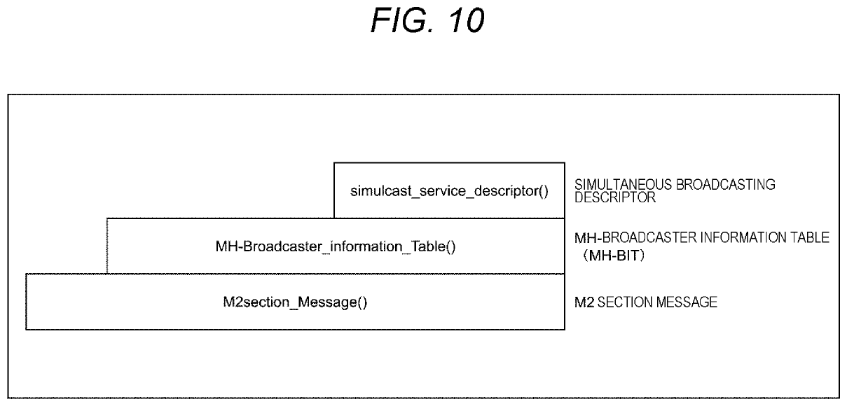

FIG. 10 is a diagram illustrating an example of arrangement position of the simultaneous broadcasting descriptor.

The simultaneous broadcasting descriptor is arranged in an MH-broadcaster information table (MH-BIT). The MH-broadcaster information table is used to present information of a broadcaster existing on the network. The MH-broadcaster information table is stored in an M2 section message. The M2 section message is used to transmit a section extension form of a MPEG-2 system.

In the MH-broadcaster information table, an MH broadcaster name descriptor (MH-Broadcaster_Name_Descriptor) that describes the name of a broadcaster is arranged, and the simultaneous broadcasting descriptor can be arranged in the same position as the MH broadcaster name descriptor.

Note that, the arrangement position illustrated in FIG. 10 is an example, and the simultaneous broadcasting descriptor may be arranged at other positions.

### (Generation of Channel List)

The reception device 20 generates a channel list that is a list of channels (programs) of receivable services at the time of initial scanning. In the channel list, service_id for identifying a receivable service is registered.

service_id can be arranged in a service description section and transmitted. The reception device 20 may register, into the channel list, service_id which is arranged in the service description section transmitted from the transmission device 10.

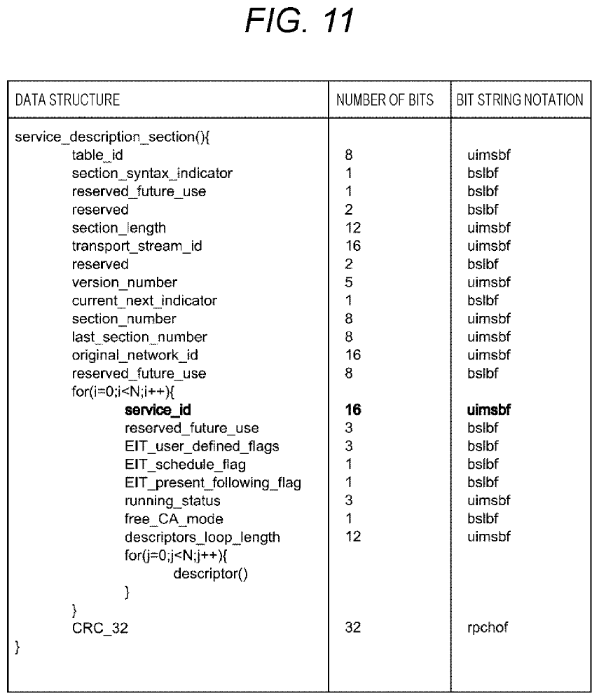

FIG. 11 illustrates an example of syntax of the service description section (service_description_section). In FIG. 11, 16-bit service_id indicates service identification. service_id serves as a label for identifying this service from other services in a transport stream.

In a case where the simultaneous broadcasting descriptor is included in the broadcast stream, and service_id arranged in the simultaneous broadcasting descriptor is registered in the channel list, the reception device 20 can determine that the broadcast signal is the simultaneous broadcasting.

In a case where remote_control_key_id is used as the information that can specify a program, remote_control_key_id arranged in a TS information descriptor transmitted from the transmission device 10 can be used. The TS information descriptor indicates specification of button identification of a remote controller allocated to the TS and correspondence relations between service identification and transmission hierarchy at the time of hierarchical transmission.

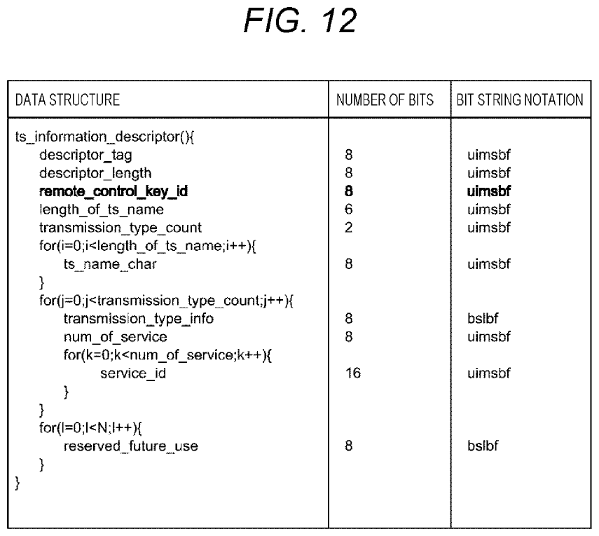

FIG. 12 illustrates an example of syntax of the TS information descriptor (ts_information_descriptor). In FIG. 12, 8-bit remote_control_key_id indicates a recommended value of button number of the remote controller to which the TS will be allocated.

In a case where the simultaneous broadcasting descriptor is included in the broadcast stream, and remote_control_key_id arranged in the simultaneous broadcasting descriptor and remote_control_key_id arranged in the TS information descriptor match, the reception device 20 can determine that the broadcast signal is the simultaneous broadcasting.

Generally, the same value of remote_control_key_id is specified in the broadcast stream by affiliated stations. Therefore, when remote_control_key_id arranged in the simultaneous broadcasting descriptor and remote_control_key_id arranged in the TS information descriptor match, it is also possible to determine that the broadcast signal is the simultaneous broadcasting regardless of comparison of the value of service_id.

Note that, the service description section and the TS information descriptor are defined in, for example, Document 1 below.

### Document 1: ARIB STD-B10 Version 5.13 Association of Radio Industries and Businesses

### (Operation at Initial Scanning)

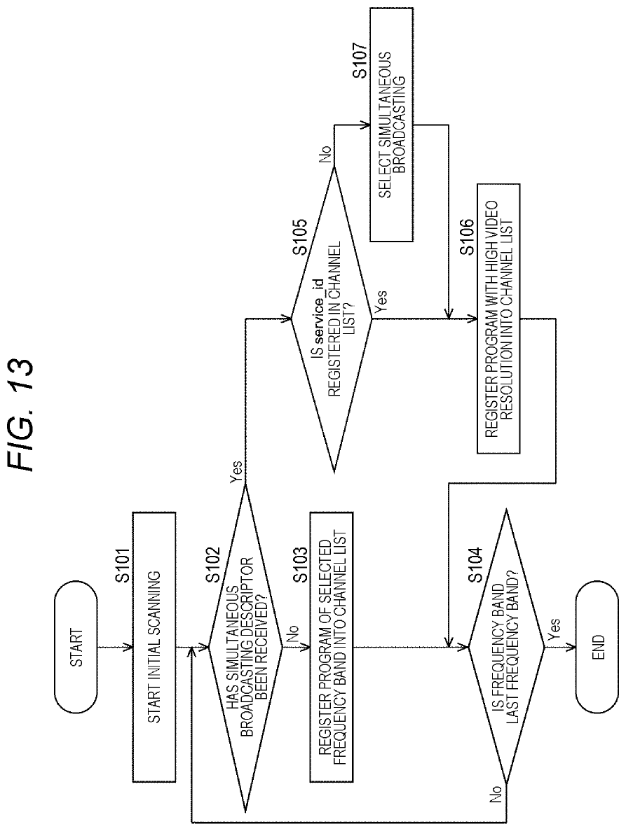

Next, an operational flow at the time of initial scanning in the reception device 20 will be described with reference to the flowchart of FIG. 13.

Here, it is assumed that the reception device 20 is a fixed receiver such as a television receiver. In the reception device 20, the initial scanning is started in a case where a predetermined operation has been performed by a user (S101).

In step S102, the processing unit 202 determines whether or not the simultaneous broadcasting descriptor included in the broadcast stream transmitted from the transmission device 10 has been received.

In step S102, in a case where it is determined that the simultaneous broadcasting descriptor has not been received, the processing proceeds to step S103. In step S103, the processing unit 202 registers, into the channel list, a program of the frequency band selected by the initial scanning. At this time, as service_id corresponding to the program, service_id arranged in the service description section or the like is registered into the channel list.

When the processing of step S103 ends, the processing proceeds to step S104. In step S104, the processing unit 202 determines whether or not the frequency band is the last frequency band in the initial scanning.

In step S104, in a case where it is determined that the frequency band is not the last frequency band, the processing returns to step S102, and the above-described processing is repeated. In the initial scanning, in order to generate a channel list that is a list of programs receivable in an area where the reception device 20 is installed, receivable broadcast signals are sequentially scanned while changing the frequency band to be selected. Then, in step S102, in a case where it is determined that the simultaneous broadcasting descriptor has been received, the processing proceeds to step S105.

For example, the simultaneous broadcasting descriptor is transmitted by the broadcasting service of the next generation system (4K broadcasting), and thus, the reception device 20 that receives the 4K broadcasting can acquire a service ID (service_id) and selection information of the broadcasting service of the current system (2K broadcasting) to be simultaneously broadcasted. However, the simultaneous broadcasting descriptor may be transmitted by the 2K broadcasting. This facilitates registration of the channel list in the reception device 20 that receives the 4K broadcasting.

In step S105, the processing unit 202 determines whether or not service_id arranged in the simultaneous broadcasting descriptor is registered in the channel list.

In step S105, in a case where it is determined that service_id is registered in the channel list, the processing proceeds to step S106. In step S106, the processing unit 202 registers a program with a high video resolution into the channel list.

That is, in a case where service_id arranged in the simultaneous broadcasting descriptor is registered in the channel list, it can be determined that the broadcast signal is the simultaneous broadcasting. In the simultaneous broadcasting, the same programs are distributed at different video resolutions. Therefore, a program with a higher video resolution out of the same programs is preferentially registered into the channel list. For example, in a case where one of the same programs is broadcasted with the 2K image quality in the broadcasting service of the current system (2K broadcasting) and the other of the same programs is broadcasted with the 4K image quality in the broadcasting service of the next generation system (4K broadcasting), the program of the broadcasting service of the next generation system in which a video program with a higher resolution is distributed is selected and registered into the channel list.

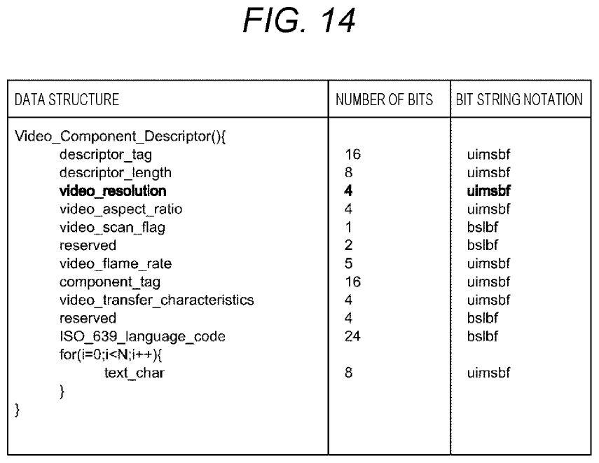

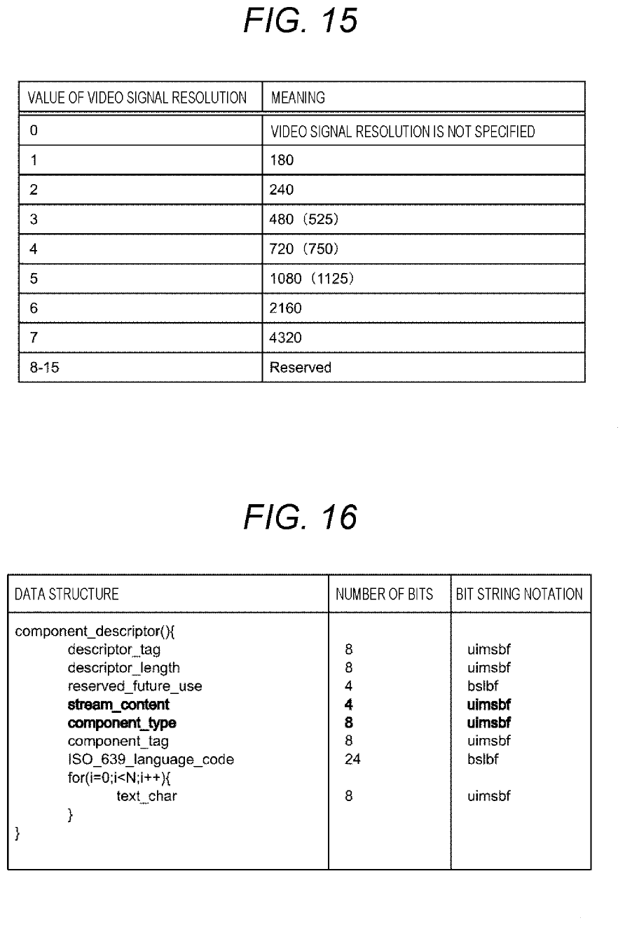

FIG. 14 illustrates an example of syntax of a video component descriptor (Video_Component_Descriptor) as a first example of transmission of video resolution information. In FIG. 14, 4-bit video_resolution indicates a video signal resolution and represents a vertical resolution of a video signal. FIG. 15 illustrates an example of a value of the video_resolution.

Note that, the video component descriptor is defined, for example, in Document 2 below.

### Document 2: ARIB STD-B60 Version 1.14 Association of Radio Industries and Businesses

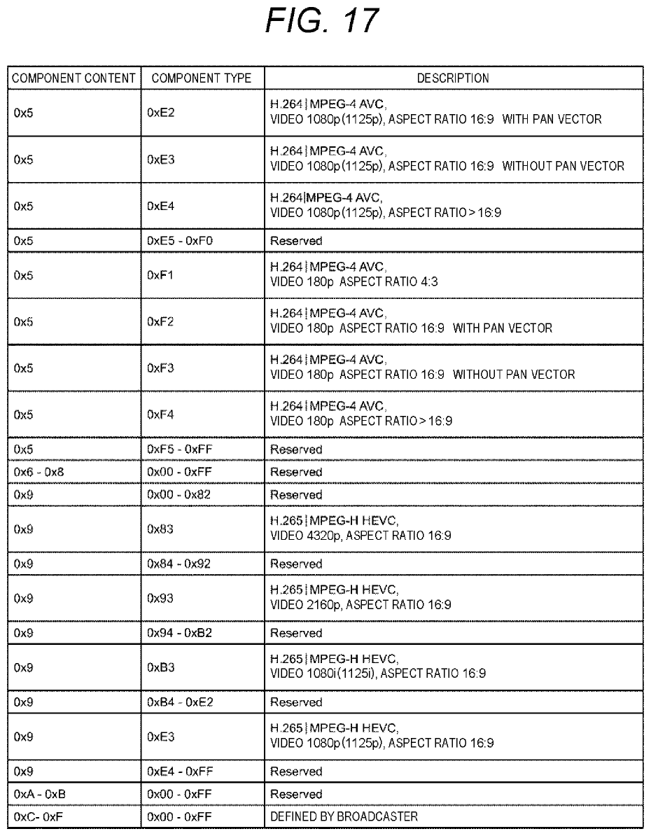

FIG. 16 illustrates an example of syntax of a component descriptor (component_descriptor) as a second example of transmission of video resolution information. In FIG. 16, 4-bit stream_content indicates the content of the component, and represents the type of the stream such as video, audio, or data. 8-bit component_type defines the type of the component such as a video, audio, and data. The contents of encoding according to the component content (stream_content) and the component type (component_type) are illustrated in FIG. 17.

Note that, the component descriptor is defined in, for example, Document 1 described above.

The processing unit 202 can preferentially select a video program with a higher resolution by referring to video_resolution arranged in the video component descriptor and stream_content and component_type arranged in the component descriptor.

On the other hand, in a case where it is determined in step S105 that service_id is not registered in the channel list, the processing proceeds to step S107. In step S107, the processing unit 202 controls the reception unit 201 in accordance with the selection information of the simultaneous broadcasting descriptor to select the simultaneous broadcasting. Then, the video resolutions of the programs of the received simultaneous broadcasting are compared, and a program with a higher video resolution is registered into the channel list (S106).

When the processing of step S106 ends, the processing proceeds to step S104. In step S104, in a case where it is determined that the frequency band is not the last frequency band, the processing returns to step S102, and the above-described processing is repeated. Then, in step S104, in a case where it is determined that the frequency band is the last frequency band, a series of processing ends.

The operational flow at the time of the initial scanning in the reception device 20 has been described above. In the operation at the time of the initial scanning, by receiving the simultaneous broadcasting descriptor which is a list of the simultaneous broadcasting in which the same programs are broadcasted, the received broadcast signal can be determined to be the simultaneous broadcasting.

In addition, in the operation at the time of the initial scanning, a program with the highest video resolution can be preferentially registered into the channel list on the basis of the video resolution information acquired from the video component descriptor, the component descriptor, or the like. This prevents a plurality of the same programs from being registered into the channel list, enabling the channel list not to include the same programs. On the other hand, a user can easily view a high-quality program.

Here, in a case where the same program is broadcasted in the broadcasting service of the next generation system (4K broadcasting) and the broadcasting service of the current system (2K broadcasting), which is simultaneously broadcasted, the 4K broadcasting and the 2K broadcasting are broadcasted in different frequency bands. For example, the 2K broadcasting that broadcasts a video program with the 2K image quality is broadcasted on channel A (Ach), and the 4K broadcasting that broadcasts a video program with the 4K image quality is broadcasted on channel B (Bch), whereby the 4K broadcasting and the 2K broadcasting are broadcasted in different frequency bands from each other (for example, different channels each having a band of 6 MHZ).

Note that, as described above, the 2K broadcasting, which is the simultaneous broadcasting, may be transmitted via communication such as the Internet. In addition, the 4K broadcasting and the 2K broadcasting do not necessarily need to be transmitted in different frequency bands, and the 4K broadcasting and the 2K broadcasting may be transmitted in the same frequency band.

### (Operation at the Time of Selection)

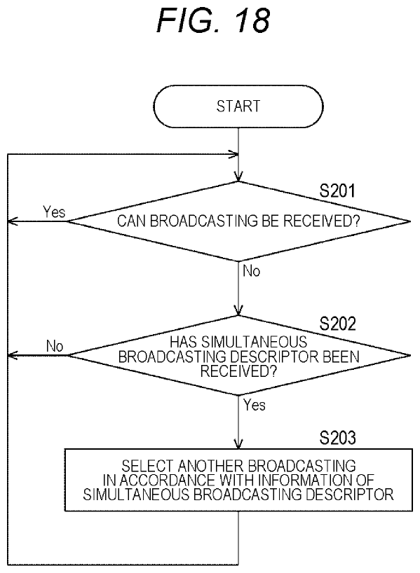

Next, an operational flow at the time of selection in the reception device 20 will be described with reference to the flowchart of FIG. 18.

Here, it is assumed that the reception device 20 is an in-vehicle receiver, and the reception environment changes as the vehicle moves.

In step S201, by monitoring the broadcast signal received by the reception unit 201 or the like, the processing unit 202 determines whether or not the broadcasting can be received.

In step S201, in a case where it is determined that the broadcasting can be received, the determination processing is repeated. In this case, in the reception device 20, the broadcast stream acquired from the received broadcast signal is processed, and the video and audio of the content such as a program are output.

On the other hand, in step S201, in a case where it is determined that the broadcast cannot be received, the processing proceeds to step S202. In step S202, the processing unit 202 determines whether or not the simultaneous broadcasting descriptor has been received.

in step S202, in a case where it is determined that the simultaneous broadcasting descriptor has been received, the processing proceeds to step S203. In step S203, the processing unit 202 controls the reception unit 201 in accordance with the selection information included in the simultaneous broadcasting descriptor to select another broadcasting (simultaneous broadcasting).

For example, in a case where the reception device 20, which is an in-vehicle receiver, cannot receive the broadcasting being selected due to change of the reception state caused by movement of the vehicle, the reception device 20 can select the simultaneous broadcasting on the basis of the selection information arranged in the simultaneous broadcasting descriptor. As a result, a user can continue viewing the same program.

When the processing of step S203 ends, the processing returns to step S201, and the above-described series of processing is repeated. Note that, in step S202, also in a case where it is determined that the simultaneous broadcasting descriptor has not been received, the processing returns to step S201, and the above-described processing is repeated.

The operational flow at the time of the selection in the reception device 20 has been described above. In the operation at the time of the selection, when the reception state of a program of the broadcasting being selected becomes poor, a program of the simultaneous broadcasting (the same program) of a good reception state can be selected on the basis of the selection information included in the simultaneous broadcasting descriptor. As described above, in particular, in a case where the reception device 20 is an in-vehicle receiver, selection of the simultaneous broadcasting is facilitated according to the reception state.

### (Flow of Processing on Transmission Side and Reception Side)

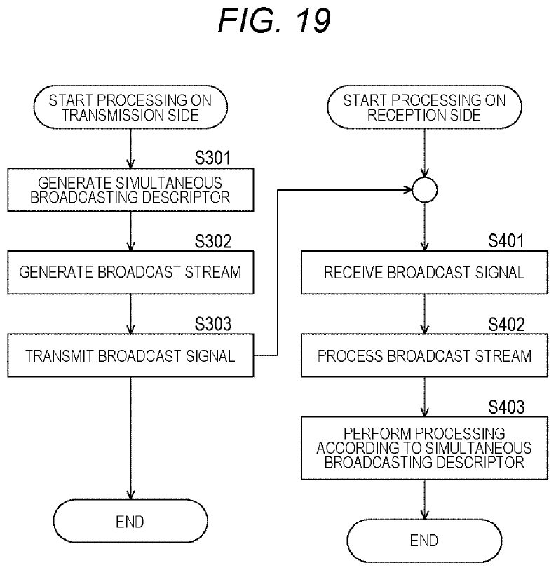

Finally, the flows of processing on the transmission side and the reception side to which the present disclosure is applied will be described with reference to the flowchart of FIG. 19.

First, processing in steps S301 to S303 performed by the transmission device 10 will be described.

In step S301, the generation unit 101 generates a simultaneous broadcasting descriptor. In the simultaneous broadcasting descriptor, at least a service ID (service identifier) or location information is arranged.

In step S302, the generation unit 101 generates a broadcast stream including a broadcast component and signaling information. The signaling information includes the simultaneous broadcasting descriptor.

In step S303, the transmission unit 102 transmits the broadcast stream as a broadcast signal. The broadcast signal from the transmission device 10 is transmitted from a transmission antenna installed in a transmission station. Note that, the broadcast signal may be transmitted via a relay station.

Next, processing of steps S401 to S403 performed by the reception device 20 will be described.

In step S401, the reception unit 201 receives the broadcast signal transmitted from the transmission device 10 via the antenna.

In step S402, the processing unit 202 processes the broadcast stream acquired from the broadcast signal. Here, the signaling information and the broadcast component are acquired from the broadcast stream. The signaling information includes the simultaneous broadcasting descriptor.

In step S403, the processing unit 202 performs processing according to the simultaneous broadcasting descriptor. For example, in a case where service_id arranged in the simultaneous broadcasting descriptor is registered in the channel list at the time of the initial scanning, it can be determined that the program indicated by service_id is a program of the simultaneous broadcasting. In addition, at the time of selection, when the reception state of a program of broadcasting being selected becomes poor, a program of a simultaneous broadcasting (the same program) of a good reception state can be selected on the basis of the selection information of the simultaneous broadcasting descriptor.

The flows of processing on the transmission side and the reception side to which the present disclosure is applied have been described above. In the present disclosure, the simultaneous broadcasting descriptor is defined at the time of starting an operation of a new broadcasting service such as the next generation system, and thus, the reception device 20 can reliably recognize that the simultaneous broadcasting is being performed.

### 2. Modification

### (Other Broadcasting Systems)

In the above description, the case where the current system is ISDB-T and the next generation system is the advanced terrestrial broadcasting system as the broadcasting system of the digital television broadcasting has been described, but the present disclosure may be applied to a combination of other broadcasting systems. The other broadcasting systems include advanced television systems committee (ATSC), ATSC 3.0, digital video broadcasting-terrestrial (DVB-T), DVB-T2, and the like.

For example, the present disclosure is also applicable to a case where the current system is ISDB-T and the next generation system is ATSC 3.0. Note that, in a case of application to ATSC 3.0, the signaling information including the simultaneous broadcasting descriptor is transmitted as a Service List Table or a Service Layer Signaling.

In addition, in the above description, the broadcasting system of the terrestrial digital television broadcasting has been described. However, the present disclosure may also be applied to a broadcasting system such as satellite broadcasting using a broadcasting satellite (BS), a communications satellite (CS), or the like, or cable broadcasting such as a cable television (CATV).

(Relationship with Electronic Program Guide)

The reception device 20 has a channel list in which programs with higher video resolutions are registered. However, in an electronic programming guide (EPG) to be separately transmitted, only a program with a higher video resolution may be displayed, or not only a program with a higher video resolution but also a program with a lower video resolution (the same program with a different video resolution) may be displayed. In either the former case or the latter case, a program with a higher video resolution than a program selected by a user may be selected in selection if the programs have the same service ID.

Note that, a newer broadcasting system may be selected instead of a program with a higher video resolution. For example, in a case where broadcasting is performed in the current system and the next generation system, the next generation system is a newer broadcasting system.

### (Transmission Via Communication)

As described above, the program of the simultaneous broadcasting can be distributed via the Internet, but the reception device 20 that has received the program of the simultaneous broadcasting via the Internet can reproduce the received program by activating a video player, a video on demand (VOD) application, or the like. Here, the video player or the VOD application is downloaded from a server on the Internet and installed or installed in advance, and can also be said to be non-broadcasting application.

Note that, in a case where the video player or the VoD application is not installed in the reception device 20, a screen prompting installation or an application store providing the VoD application or the like can be displayed.

In addition, the reception device 20 may display, on an electronic program guide (EPG), information regarding the program of the simultaneous broadcasting distributed via the Internet. In other words, it can be said that the displayed information is information regarding a VoD distribution service or a non-broadcasting service.

### (Selection of Simultaneous Broadcasting Based on User Setting)

The reception device 20 may select the simultaneous broadcasting on the basis of user setting. Specifically, for example, an item for selecting whether or not to perform the selection processing to select the simultaneous broadcasting or the registration processing of the simultaneous broadcasting to the channel list may be provided in the setting menu for setting the reception device 20. In addition, an item for selecting which of the broadcasting service of the next generation system and the broadcasting service of the simultaneous broadcasting is selected or registered may be provided in the setting menu. By acquiring user selection using such a setting menu, the reception device 20 can prevent a program of a poor reception state from being forcibly selected.

### (Video Quality)

In the present specification, the “2K image quality” is video corresponding to a screen resolution of approximately 1920×1080 pixels. In addition, the “4K image quality” is video corresponding to a screen resolution of approximately 3840×2160 pixels. In the above description, the case where the image quality with a higher video resolution is the 4K image quality has been described, but the image quality with a higher video resolution may be a much higher image quality, for example, the 8K image quality. The “8K image quality” is for video corresponding to a screen resolution of approximately 7680×4320 pixels.

In the above description, a program with a higher video resolution out of the same programs is registered into the channel list (S106 of FIG. 13), but the quality of video is not limited to the resolution, and other qualities may be compared. For example, in a case where a higher-quality video is provided by increasing luminance by a high dynamic range (HDR) technology, widening color gamut, increasing display images (frames) per second, or the like, programs corresponding to such higher-quality video can be registered into the channel list.

### (Names of Descriptors and the Like)

Other names may be used as the names of descriptors, fields, packets, streams, and the like described above. For example, the TLV packet may be referred to as ATSC Link-layer Protocol (ALP) packet or the like. The difference between these names is a formal difference, and substantial content of descriptors or the like that are referred are not different. Note that, in the present specification, a system refers to a logical assembly of a plurality of devices.

### (Configuration of Computer)

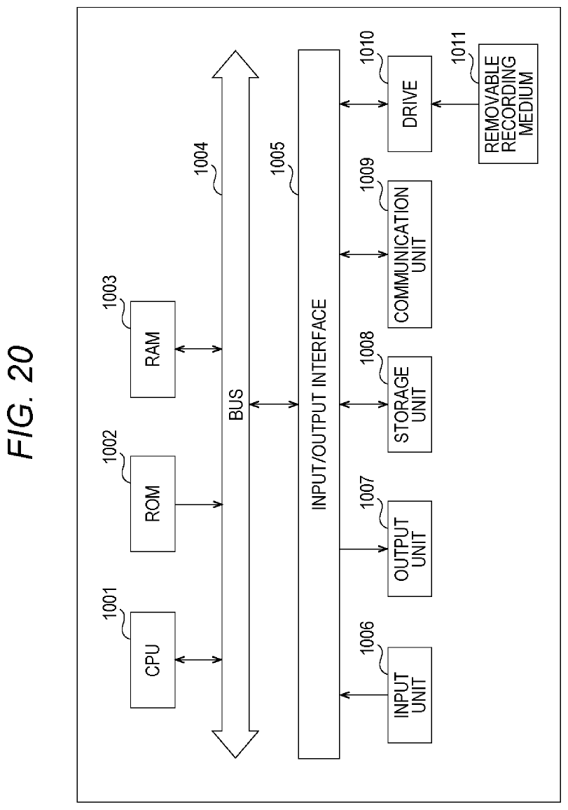

A series of processing on the transmission side and the reception side described above can also be performed by hardware or software. In a case where the series of processing is performed by the software, the program constituting the software is installed on a computer. FIG. 20 is a block diagram illustrating a configuration example of hardware of a computer that performs the above-described series of processing by the program.

In the computer, a central processing unit (CPU) 1001, a read only memory (ROM) 1002, and a random access memory (RAM) 1003 are connected to each other by a bus 1004. An input/output interface 1005 is further connected to the bus 1004. An input unit 1006, an output unit 1007, a storage unit 1008, a communication unit 1009, and a drive 1010 are connected to the input/output interface 1005.

The input unit 1006 includes a keyboard, a mouse, a microphone and the like. The output unit 1007 includes a display, a speaker, and the like. The storage unit 1008 includes a hard disk, a nonvolatile memory, and the like. The communication unit 1009 includes a network interface and the like. The drive 1010 drives a removable recording medium 1011 such as a semiconductor memory, a magnetic disk, an optical disk, or a magneto-optical disk.

In the computer configured as described above, the CPU 1001 loads the program recorded in the ROM 1002 or the storage unit 1008 into the RAM 1003 via the input/output interface 1005 and the bus 1004 and executes the program, whereby the above-described series of processing is performed.

The program executed by the computer (CPU 1001) can be provided by being recorded in the removable recording medium 1011 as a package medium or the like, for example. In addition, the program can be provided via a wired or wireless transmission medium such as a local area network, the Internet, or digital satellite broadcasting.

In the computer, the program can be installed on the storage unit 1008 via the input/output interface 1005 by attaching the removable recording medium 1011 to the drive 1010. In addition, the program can be received by the communication unit 1009 via the wired or wireless transmission medium and installed on the storage unit 1008. Besides, the program can be installed on the ROM 1002 or the storage unit 1008 in advance.

Here, in the present specification, the processing performed by the computer according to the program is not necessarily performed in time series in the order described as the flowchart. That is, the processing performed by the computer according to the program also includes processing that is performed in parallel or individually (for example, parallel processing or object processing). In addition, the program may be processed by one computer (processor) or may be processed in a distributed manner by a plurality of computers.

Note that, the embodiment of the present disclosure is not limited to the above-described embodiments, and various modifications can be made without departing from the scope of the present disclosure. In addition, the effects described in the present specification are merely examples and are not limited, and other effects may be provided.

In addition, the present disclosure can have the following configurations.

(1) A transmission device including:
a generation unit that generates a broadcast stream including a broadcast component constituting content and signaling information regarding the broadcast component; and
a transmission unit that transmits the broadcast stream, in which
the signaling information includes a descriptor in which a service identifier or location information for identifying simultaneous broadcasting content corresponding to the content is arranged.

(2) The transmission device according to (1), in which
the descriptor is an identifier for identifying a service corresponding to the simultaneous broadcasting content among one or more services included in a transmission stream for transmitting the simultaneous broadcasting content.

(3) The transmission device according to (1) or (2), in which
in the descriptor, a button number of a remote controller to which the service corresponding to the simultaneous broadcasting content is allocated is arranged.

(4) The transmission device according to any one of (1) to (3), in which
in the descriptor, an identifier for identifying a multiplexing stream including a broadcast component and signaling information of the simultaneous broadcasting content is arranged.

(5) The transmission device according to any one of (1) to (4), in which
the descriptor further includes selection information for selecting the simultaneous broadcasting content.

(6) The transmission device according to (5), in which
the selection information includes information regarding any of a center frequency, a transmission mode, and a guard interval.

(7) The transmission device according to (5) or (6), in which
in the descriptor, the service identifier or the location information, and the selection information are arranged for each type indicating a system of simultaneous broadcasting.

(8) The transmission device according to any one of (1) to (7), in which
the signaling information includes video resolution information regarding video resolutions of the content and the simultaneous broadcasting content.

(9) The transmission device according to any one of (1) to (8), in which
the content and the simultaneous broadcasting content are transmitted in different frequency bands.

(10) A transmission method performed by a transmission device, including:
generating a broadcast stream including a broadcast component constituting content and signaling information regarding the broadcast component, the signaling information including a descriptor in which a service identifier or location information for identifying simultaneous broadcasting content corresponding to the content is arranged; and transmitting the broadcast stream.

(11) A reception device including:
a reception unit that receives a broadcast stream including a broadcast component constituting content and signaling information regarding the broadcast component; and
a processing unit that processes the broadcast component on the basis of the signaling information, in which
the signaling information includes a descriptor in which a service identifier or location information for identifying simultaneous broadcasting content corresponding to the content is arranged.

(12) The reception device according to (11), in which
the descriptor is an identifier for identifying a service corresponding to the simultaneous broadcasting content among one or more services included in a transmission stream for transmitting the simultaneous broadcasting content.

(13) The reception device according to (11) or (12), in which
in the descriptor, a button number of a remote controller to which the service corresponding to the simultaneous broadcasting content is allocated is arranged.

(14) The reception device according to any one of (11) to (13), in which
in the descriptor, an identifier for identifying a multiplexing stream including a broadcast component and signaling information of the simultaneous broadcasting content is arranged.

(15) The reception device according to any one of (11) to (14), in which
the descriptor further includes selection information for selecting the simultaneous broadcasting content, and
the processing unit selects the simultaneous broadcasting content on the basis of the selection information.

(16) The reception device according to (15), in which
the selection information includes information regarding any of a center frequency, a transmission mode, and a guard interval.

(17) The reception device according to (15) or (16), in which
in the descriptor, the service identifier or the location information, and the selection information are arranged for each type indicating a system of simultaneous broadcasting.

(18) The reception device according to any one of (11) to (17), in which
the signaling information includes video resolution information regarding video resolutions of the content and the simultaneous broadcasting content, and
the processing unit preferentially selects one of the content and the simultaneous broadcasting content with a higher video resolution on the basis of the video resolution information.

(19) The reception device according to any one of (11) to (18), in which
the content and the simultaneous broadcasting content are transmitted in different frequency bands.

(20) The reception device according to (13), in which
the processing unit identifies the simultaneous broadcasting content on the basis of comparison with the button number of the remote controller to which the service corresponding to the simultaneous broadcasting content is allocated.

### REFERENCE SIGNS LIST

10 Transmission device
20 Reception device
30 Transmission path
101 Generation unit
102 Transmission unit
201 Reception unit
202 Processing unit
1001 CPU

1. A transmission device comprising:
a generation unit that generates a broadcast stream including a broadcast component constituting content and signaling information regarding the broadcast component; and
a transmission unit that transmits the broadcast stream, wherein
the signaling information includes a descriptor in which a service identifier or location information for identifying simultaneous broadcasting content corresponding to the content is arranged.

2. The transmission device according to claim 1, wherein
the descriptor is an identifier for identifying a service corresponding to the simultaneous broadcasting content among one or more services included in a transmission stream for transmitting the simultaneous broadcasting content.

3. The transmission device according to claim 1, wherein
in the descriptor, a button number of a remote controller to which the service corresponding to the simultaneous broadcasting content is allocated is arranged.

4. The transmission device according to claim 1, wherein
in the descriptor, an identifier for identifying a multiplexing stream including a broadcast component and signaling information of the simultaneous broadcasting content is arranged.

5. The transmission device according to claim 1, wherein
the descriptor further includes selection information for selecting the simultaneous broadcasting content.

6. The transmission device according to claim 5, wherein
the selection information includes information regarding any of a center frequency, a transmission mode, and a guard interval.

7. The transmission device according to claim 5, wherein
in the descriptor, the service identifier or the location information and the selection information are arranged for each type indicating a system of simultaneous broadcasting.

8. The transmission device according to claim 1, wherein
the signaling information includes video resolution information regarding video resolutions of the content and the simultaneous broadcasting content.

9. The transmission device according to claim 1, wherein
the content and the simultaneous broadcasting content are transmitted in different frequency bands.

10. A transmission method performed by a transmission device, comprising:
generating a broadcast stream including a broadcast component constituting content and signaling information regarding the broadcast component, the signaling information including a descriptor in which a service identifier or location information for identifying simultaneous broadcasting content corresponding to the content is arranged; and
transmitting the broadcast stream.

11. A reception device comprising:
a reception unit that receives a broadcast stream including a broadcast component constituting content and signaling information regarding the broadcast component; and
a processing unit that processes the broadcast component on a basis of the signaling information, wherein
the signaling information includes a descriptor in which a service identifier or location information for identifying simultaneous broadcasting content corresponding to the content is arranged.

12. The reception device according to claim 11, wherein
the descriptor is an identifier for identifying a service corresponding to the simultaneous broadcasting content among one or more services included in a transmission stream for transmitting the simultaneous broadcasting content.

13. The reception device according to claim 11, wherein
in the descriptor, a button number of a remote controller to which the service corresponding to the simultaneous broadcasting content is allocated is arranged.

14. The reception device according to claim 11, wherein
in the descriptor, an identifier for identifying a multiplexing stream including a broadcast component and signaling information of the simultaneous broadcasting content is arranged.

15. The reception device according to claim 11, wherein
the descriptor further includes selection information for selecting the simultaneous broadcasting content, and
the processing unit selects the simultaneous broadcasting content on a basis of the selection information.

16. The reception device according to claim 15, wherein
the selection information includes information regarding any of a center frequency, a transmission mode, and a guard interval.

17. The reception device according to claim 15, wherein
in the descriptor, the service identifier or the location information and the selection information are arranged for each type indicating a system of simultaneous broadcasting.

18. The reception device according to claim 11, wherein
the signaling information includes video resolution information regarding video resolutions of the content and the simultaneous broadcasting content, and
the processing unit preferentially selects one of the content and the simultaneous broadcasting content with a higher video resolution on a basis of the video resolution information.

19. The reception device according to claim 11, wherein
the content and the simultaneous broadcasting content are transmitted in different frequency bands.

20. The reception device according to claim 13, wherein
the processing unit identifies the simultaneous broadcasting content on a basis of comparison with the button number of the remote controller to which the service corresponding to the simultaneous broadcasting content is allocated.
